(19) United States
(12) Patent Application Publication
(10) Pub. No.: US 2012/0214086 A1
(43) Pub. Date: Aug. 23, 2012

(54) METHOD OF FABRICATING A POLYMER ELECTROLYTE MEMBRANE (PEM)

(75) Inventors: Xinhuai YE, State College, PA (US); Takashi Akiyama, Osaka (JP); Chao-Yang Wang, State College, PA (US)

(73) Assignees: The Penn State Research Foundation, University Park, PA (US); Panasonic Corporation, Osaka (JP)

(21) Appl. No.: 13/453,815

(22) Filed: Apr. 23, 2012

Related U.S. Application Data
(62) Division of application No. 13/206,290, filed on Aug. 9, 2011.
Application No. 13/206,290 is a division of application No. 11/889,109, filed on Aug. 9, 2007, now abandoned.

(51) Int. Cl. H01M 8/10

(52) U.S. Cl. 429/482; 429/492; 429/494

(57) ABSTRACT

A proton (H⁺)-conducting hydrocarbon (HC)-based polymer electrolyte membrane (PEM) having first and second oppositely facing surfaces comprises a HC-based membrane with at least one perfluoropolymer incorporated on or within at least the first and second surfaces. A method for fabricating the PEM comprises surface treating a HC-based polymeric membrane sheet via immersion in an aqueous solution or dispersion of said at least one perfluoropolymer, followed by drying of the surface treated polymeric membrane sheet.

### FIELD OF THE DISCLOSURE

The present disclosure relates generally to fuel cells, fuel cell systems, and polymer electrolyte membranes for same. More specifically, the present disclosure relates to surface-treated polymer electrolyte membranes for direct oxidation fuel cells, such as direct methanol fuel cells, and their fabrication method.

### BACKGROUND OF THE DISCLOSURE

A direct oxidation fuel cell (hereinafter “DOFC”) is an electrochemical device that generates electricity from electrochemical oxidation of a liquid fuel. DOFC's do not require a preliminary fuel processing stage; hence, they offer considerable weight and space advantages over indirect fuel cells, i.e., cells requiring preliminary fuel processing. Liquid fuels of interest for use in DOFC's include methanol (“MeOH”), formic acid, dimethyl ether, etc., and their aqueous solutions. The oxidant may be substantially pure oxygen or a dilute stream of oxygen, such as that in air. Significant advantages of employing a DOFC in portable and mobile applications (e.g., notebook computers, mobile phones, personal data assistants, etc.) include easy storage/handling and high energy density of the liquid fuel.

One example of a DOFC system is a direct methanol fuel cell (hereinafter “DMFC”). A DMFC generally employs a membrane-electrode assembly (hereinafter “MEA”) having an anode, a cathode, and a proton-conducting polymer electrolyte membrane (hereinafter “PEM”) positioned therebetween. A typical example of a PEM is one composed of a perfluorosulfonic acid-tetrafluorethylene copolymer having a hydrophobic fluorocarbon backbone and perfluoroether side chains containing a strongly hydrophilic pendant sulfonic acid group (SO₃H), such as Nafion® (Nafion® is a registered trademark of E.I. Dupont de Nemours and Company). When exposed to H₂O, the hydrolyzed form of the sulfonic acid group (SO₃⁻H₃O⁺) allows for effective proton (H⁺) transport across the membrane, while providing thermal, chemical, and oxidative stability. In a DMFC, a methanol/water solution is directly supplied to the anode as the fuel and air is supplied to the cathode as the oxidant. At the anode, the methanol reacts with the water in the presence of a catalyst, typically a Pt or Ru metal-based catalyst, to produce carbon dioxide, H⁺ ions (protons), and electrons. The electrochemical reaction is shown as equation (1) below:

CH₃OH+H₂O→CO₂+6H⁺+6e⁻ (1)

During operation of the DMFC, the protons migrate to the cathode through the proton-conducting membrane electrolyte, which is non-conductive to electrons. The electrons travel to the cathode through an external circuit for delivery of electrical power to a load device. At the cathode, the protons, electrons, and oxygen molecules, typically derived from air, are combined to form water. The electrochemical reaction is given in equation (2) below:

3/2O₂+6H⁺+6e⁻→3H₂O (2)

Electrochemical reactions (1) and (2) form an overall cell reaction as shown in equation (3) below:

CH₃OH+3/2O₂→CO₂+2H₂O (3)

The ability to use highly concentrated fuel is desirable for portable power sources, particularly since DMFC technology is currently competing with advanced batteries, such as those based upon lithium-ion technology.

Notwithstanding the above-described advantageous characteristics of perfluorosulfonic acid-tetrafluorethylene copolymers (e.g., Nafion®) when utilized as a PEM in DOFCs, a drawback of perfluorinated membranes is their propensity for methanol (CH₃OH) to partly permeate the membrane, such permeated methanol being termed “crossover methanol”. The crossover methanol reacts with oxygen at the cathode, causing a reduction in fuel utilization efficiency and cathode potential, with a corresponding reduction in power generation of the fuel cell. It is thus conventional for DMFC systems to use excessively dilute (3-6% by vol.) methanol solutions for the anode reaction in order to limit methanol crossover and its detrimental consequences. However, a problem with such a DMFC system is that it requires a significant amount of water to be carried in a portable system, thus diminishing the system energy density.

In view of the foregoing, it is considered desirable for the PEMs of DMFCs to have high proton (i.e., H⁺) conductivity and low methanol crossover rate. Disadvantageously however, currently available, state of the art perfluorinated PEMs have relatively high methanol crossover rates which adversely affect fuel cell performance due to cathode mixed potentials and low fuel efficiency. As a consequence, much research effort has focused on developing alternative PEMs having lower methanol crossover rates along with minimum reduction in proton conductivity. In this regard, hydrocarbon-based PEMs have evidenced promise in attaining these attributes, and several hydrocarbon-based (“HC”) PEMs have demonstrated low methanol crossover rates and other favorable attributes, such as excellent chemical and mechanical stability. However, their relatively low proton conductivity and high membrane resistance limits obtainment of high power densities. In addition, HC-based PEMs are incompatible with ionomer bonded electrodes comprising perfluorosulfonic acid-tetrafluorethylene copolymers, such as Nafion®, and give rise to high interfacial resistance between the membrane and electrode. Furthermore, difficulty occurs in transferring the catalyst layer onto the membrane via the commonly utilized decal hot-pressing procedure. Specifically, failures due to membrane-electrode delamination and significant increase in cell resistance have been observed when dissimilar PEMs are utilized with conventional Nafion®-bonded electrodes via commonly employed decal hot pressing or coating procedures.

In view of the foregoing, there exists a need for improved PEMs for DOFC/DMFC systems and methodologies for fabricating same, and improved membranes that afford low methanol crossover with minimal reduction in proton conductivity to facilitate optimal performance operation of such systems with very highly concentrated fuel and high power efficiency.

### SUMMARY OF THE DISCLOSURE

Advantages of the present disclosure include polymer electrolyte membranes (PEMs) having improved features and methods of fabricating PEMs.

Additional advantages and features of the present disclosure will be set forth in the disclosure which follows and in part will become apparent to those having ordinary skill in the art upon examination of the following or may be learned from the practice of the present disclosure. The advantages may be realized and obtained as particularly pointed out in the appended claims.

According to an aspect of the present disclosure, the foregoing and other advantages are achieved in part by a method of fabricating a polymer electrolyte membrane (PEM), comprising steps of:

(a) providing a hydrocarbon-based (“HC”) polymeric membrane sheet comprising a pair of oppositely facing surfaces; and

(b) treating the pair of surfaces of the membrane with at least one perfluopolymer to incorporate the perfluoropolymer on or within at least the pair of surfaces.

According to embodiments of the present disclosure, the HC-based polymeric membrane sheet can comprise a HC polymer material selected from the group consisting of: poly-(arylene ether ether ketone) (“PEEK”), sulfonated poly-(arylene ether ether ketone) (“SPEEK”), sulfonated poly-(ether ether ketone ketone) (“SPEEKK”), sulfonated poly-(arylene ether sulfone) (“SPES”), sulfonated poly-(arylene ether benzonitrile), sulfonated polyimides (“SPI”s), sulfonated poly-(styrene), and sulfonated poly-(styrene-b-isobutylene-b-styrene) (“S-SIBS”). The HC-based polymeric membrane sheet comprises a HC polymer material having an appropriate thickness, such as from about 15 to about 200 μm, or any thickness therebetween.

In accordance with embodiments of the present disclosure, the perfluoropolymer can be selected from the group consisting of: perfluorinated sulfonic acids (e.g., Nafion®, Flemion®, Aciplex®), sulfonated tetrafluoroethylene, carboxylic fluoroploymers, and their variations with different equivalent weights (EW), where EW represents the weight of dry polymer per mole of sulfonic acid groups when in the acid form.

According to a preferred embodiment of the present disclosure, step (b) comprises treating the HC-based polymeric membrane sheet via immersion in an aqueous solution or dispersion of at least one perfluoropolymer for a predetermined interval at a predetermined temperature, followed by drying of the treated polymeric membrane sheet via hot pressing for a predetermined interval at a predetermined elevated temperature and pressure.

Other aspects of the present disclosure include surface treated HC-based PEMs and membrane electrode assemblies (MEAs) comprising anode and cathode electrodes sandwiching the treated HC-based PEMs.

Yet another aspect of the present disclosure is a proton (H⁺)-conducting HC-based polymer electrolyte membrane (PEM) having first and second oppositely facing surfaces, comprising a HC-based membrane with at least one perfluoropolymer, such as a perfluorosulfonic acid-tetrafluorethylene copolymer, incorporated on or within at least said first and second surfaces thereof.

Still another aspect of the present disclosure is a membrane electrode assembly (MEA), comprising:

(a) a proton (H⁺)-conducting polymeric electrolyte membrane (PEM) having oppositely facing first and second surfaces;

(b) an anode electrode adjacent the first surface; and

(c) a cathode electrode adjacent the second surface, wherein the PEM comprises a HC-based membrane with at least one perfluoropolymer incorporated on or within at least the first and second surfaces thereof.

Additional aspects of the present disclosure include direct oxidation fuel cell (DOFC) and direct methanol fuel cell (DMFC) systems comprising the above MEA.

Additional advantages of the present disclosure will become readily apparent to those skilled in this art from the following detailed description, wherein only the preferred embodiments of the present disclosure are shown and described, simply by way of illustration without limitation of the best mode contemplated for practicing the present disclosure. As will be realized, the disclosure is capable of other and different embodiments, and its several details are capable of modification in various obvious respects, all without departing from the spirit of the present invention. Accordingly, the drawings and description are to be regarded as illustrative in nature, and not as restrictive.

### BRIEF DESCRIPTION OF THE DRAWINGS

The various features and advantages of the present disclosure will become more apparent and facilitated by reference to the accompanying drawings, provided for purposes of illustration only and not to limit the scope of the invention, wherein the same reference numerals are employed throughout for designating like features and the various features are not necessarily drawn to scale but rather are drawn as to best illustrate the pertinent features, wherein:

FIG. 1 is a simplified, schematic illustration of a DOFC system capable of operating with highly concentrated methanol fuel, i.e., a DMFC system;

FIG. 2 is a schematic, cross-sectional view of a representative configuration of a MEA suitable for use in a fuel cell/fuel cell system such as the DOFC/DMFC system of FIG. 1;

FIG. 3 is a graph illustrating the electrical resistance of Nafion®-112 and surface treated and untreated HC PEMs, as a function of elapsed time of operation in a DMFC operating with 2M MeOH at 60° C.;

FIG. 4 is a graph illustrating the steady-state voltage performance of DMFCs operating at 1 atm. with 2M MeOH at 65° C. with Nafion®-112 and surface treated and untreated HC PEMs, as a function of elapsed time of operation;

FIG. 5 is a graph illustrating the steady-state voltage performance of DMFCs operating at 1 atm. with 4M MeOH at 65° C. with Nafion®-112 and surface treated and untreated HC PEMs, as a function of elapsed time of operation;

FIG. 6 is a graph illustrating the open circuit MeOH crossover performance of DMFCs operating with 2M MeOH at 65° C. with Nafion®-112 and surface treated and untreated HC PEMs; and

FIG. 7 is a graph illustrating the open circuit MeOH crossover performance of DMFCs operating with 4M MeOH at 65° C. with Nafion®-112 and surface treated and untreated HC PEMs.

### DETAILED DESCRIPTION OF THE DISCLOSURE

The present disclosure relates to fuel cells and fuel cell systems with high power conversion efficiency, such as DOFC's and DOFC systems operating with highly concentrated fuel, e.g., DMFC's and DMFC systems fueled with about 2 to about 25 M MeOH solutions. The present disclosure further relates to fuel cells having improved PEMs for use in electrodes/electrode assemblies therefor, and to methodology for fabricating same.

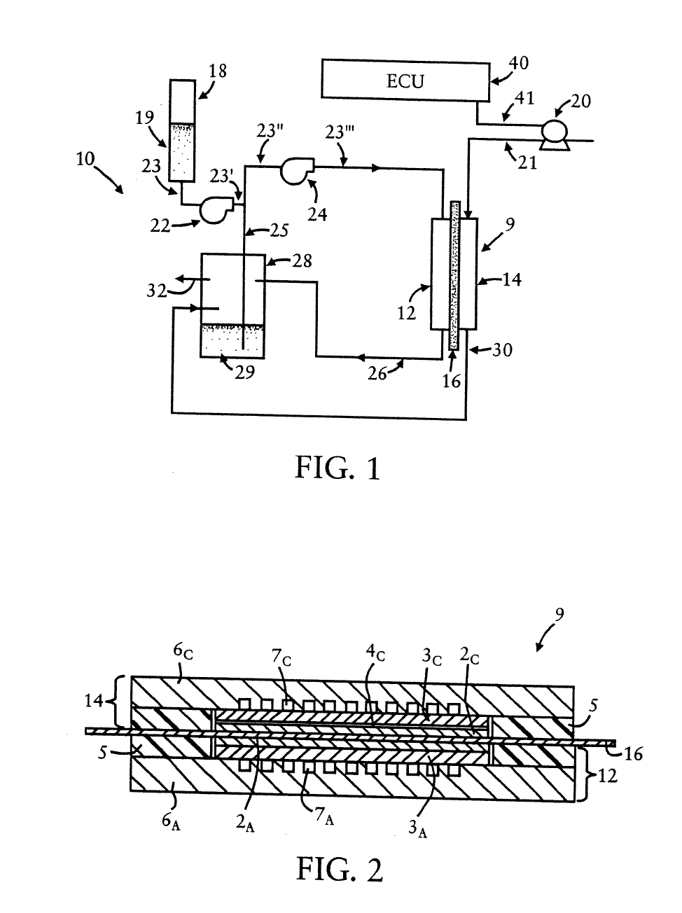

Referring to FIG. 1, schematically shown therein is an illustrative embodiment of a DOFC system adapted for operating with highly concentrated fuel, e.g., a DMFC system 10, which system maintains a balance of water in the fuel cell and returns a sufficient amount of water from the cathode to the anode under high-power and elevated temperature operating conditions. (A DOFC/DMFC system is disclosed in a co-pending, commonly assigned application filed Dec. 27, 2004, published Jun. 29, 2006 as U.S. Patent Publication US 2006-0141338 A1).

As shown in FIG. 1, DMFC system 10 includes an anode 12, a cathode 14, and a proton-conducting PEM 16, forming a multi-layered composite membrane-electrode assembly or structure 9 commonly referred to as an MEA. Typically, a fuel cell system such as DMFC system 10 will have a plurality of such MEA's in the form of a stack; however, FIG. 1 shows only a single MEA 9 for illustrative simplicity. Frequently, the MEA's 9 are separated by bipolar plates that have serpentine channels for supplying and returning fuel and by-products to and from the assemblies (not shown for illustrative convenience). In a fuel cell stack, MEAs and bipolar plates are aligned in alternating layers to form a stack of cells and the ends of the stack are sandwiched with current collector plates and electrical insulation plates, and the entire unit is secured with fastening structures. Also not shown in FIG. 1, for illustrative simplicity, is a load circuit electrically connected to the anode 12 and cathode 14.

A source of fuel, e.g., a fuel container or cartridge 18 containing a highly concentrated fuel 19 (e.g., methanol), is in fluid communication with anode 12 (as explained below). An oxidant, e.g., air supplied by fan 20 and associated conduit 21, is in fluid communication with cathode 14. The highly concentrated fuel from fuel cartridge 18 is fed directly into liquid/gas (hereinafter “L/G”) separator 28 by pump 22 via associated conduit segments 23′ and 25, or directly to anode 12 via pumps 22 and 24 and associated conduit segments 23, 23′, 23″, and 23″′.

In operation, highly concentrated fuel 19 is introduced to the anode side of the MEA 9, or in the case of a cell stack, to an inlet manifold of an anode separator of the stack. Water produced at the cathode 14 side of MEA 9 or cathode cell stack via electrochemical reaction (as expressed by equation (2)) is withdrawn therefrom via cathode outlet or exit port/conduit 30 and supplied to L/G separator 28. Similarly, excess fuel, water, and carbon dioxide gas are withdrawn from the anode side of the MEA 9 or anode cell stack via anode outlet or exit port/conduit 26 and supplied to L/G separator 28. The air or oxygen is introduced to the cathode side of the MEA 9 and regulated to maximize the amount of electrochemically produced water in liquid form while minimizing the amount of electrochemically produced water vapor, thereby minimizing the escape of water vapor from system 10.

During operation of system 10, air is introduced to the cathode 14 (as explained above) and excess air and liquid water are withdrawn therefrom via cathode exit port/conduit 30 and supplied to L/G separator 28. As discussed further below, the input air flow rate or air stoichiometry is controlled to maximize the amount of the liquid phase of the electrochemically produced water while minimizing the amount of the vapor phase of the electrochemically produced water. Control of the oxidant stoichiometry ratio can be obtained by setting the speed of fan 20 at a rate depending on the fuel cell system operating conditions or by an electronic control unit (hereinafter “ECU”) 40, e.g., a digital computer-based controller or equivalently performing structure. ECU 40 receives an input signal from a temperature sensor in contact with the liquid phase 29 of L/G separator 28 (not shown in the drawing for illustrative simplicity) and adjusts the oxidant stoichiometry ratio (via line 41 connected to oxidant supply fan 20) to maximize the liquid water phase in the cathode exhaust and minimize the water vapor phase in the exhaust, thereby reducing or obviating the need for a water condenser to condense water vapor produced and exhausted from the cathode of the MEA 2. In addition, ECU 40 can increase the oxidant stoichiometry beyond the minimum setting during cold-start in order to avoid excessive water accumulation in the fuel cell.

Liquid water 29 which accumulates in the L/G separator 28 during operation may be returned to anode 12 via circulating pump 24 and conduit segments 25, 23″, and 23″′. Exhaust carbon dioxide gas is released through port 32 of L/G separator 28.

As indicated above, cathode exhaust water, i.e., water which is electrochemically produced at the cathode during operation, is partitioned into liquid and gas phases, and the relative amounts of water in each phase are controlled mainly by temperature and air flow rate. The amount of liquid water can be maximized and the amount of water vapor minimized by using a sufficiently small oxidant flow rate or oxidant stoichiometry. As a consequence, liquid water from the cathode exhaust can be automatically trapped within the system, i.e., an external condenser is not required, and the liquid water can be combined in sufficient quantity with a highly concentrated fuel, e.g., greater than about 5 M solution, for use in performing the anodic electrochemical reaction, thereby maximizing the concentration of fuel and storage capacity and minimizing the overall size of the system. The water can be recovered in any suitable existing type of L/G separator 28, e.g., such as those typically used to separate carbon dioxide gas and aqueous methanol solution.

The DOFC/DMFC system 10 shown in FIG. 1 comprises at least one MEA 9 which includes a PEM 16 and a pair of electrodes (an anode 12 and a cathode 14) each composed of a catalyst layer and a gas diffusion layer sandwiching the membrane. Typical PEM materials include fluorinated polymers having perfluorosulfonate groups (as described above) or HC polymers, e.g., poly-(arylene ether ether ketone) (hereinafter “PEEK”). The PEM can be of any suitable thickness as, for example, between about 25 and about 180 μm. The catalyst layer typically comprises platinum (Pt) or ruthenium (Ru) based metals, or alloys thereof. The anodes and cathodes are typically sandwiched by bipolar separator plates having channels to supply fuel to the anode and an oxidant to the cathode. A fuel cell stack can contain a plurality of such MEA's 9 with at least one electrically conductive separator placed between adjacent MEA's to electrically connect the MEA's in series with each other, and to provide mechanical support.

ECU 40 can adjust the oxidant flow rate or stoichiometric ratio to maximize the liquid water phase in the cathode exhaust and minimize the water vapor phase in the exhaust, thereby eliminating the need for a water condenser.

In the above, it is assumed, though not required, that the amount of liquid (e.g., water) produced by electrochemical reaction in MEA 9 and supplied to L/G separator 28 is essentially constant, whereby the amount of liquid product returned to the inlet of anode 12 via pump 24 and conduit segments 25, 23″, and 23″′ is essentially constant, and is mixed with concentrated liquid fuel 19 from fuel container or cartridge 18 in an appropriate ratio for supplying anode 12 with fuel at an ideal concentration.

Referring now to FIG. 2, shown therein is a schematic, cross-sectional view of a representative configuration of a MEA 9 for illustrating its various constituent elements in more detail. As illustrated, a cathode electrode 14 and an anode electrode 12 sandwich a PEM 16 made of a material, such as described above, adapted for transporting hydrogen ions from the anode to the cathode during operation. The anode electrode 12 comprises, in order from PEM 16, a metal-based catalyst layer 2_{A} in contact therewith, and an overlying gas diffusion layer (hereinafter “GDL”) 3_{A}, whereas the cathode electrode 14 comprises, in order from electrolyte membrane 16: (1) a metal-based catalyst layer 2_{C} in contact therewith; (2) an intermediate, hydrophobic microporous layer (hereinafter “MPL”) 4_{C}; and (3) an overlying gas diffusion medium (hereinafter “GDM”) 3_{C}. GDL 3_{A} and GDM 3_{C} are each gas permeable and electrically conductive, and may be comprised of a porous carbon-based material including a carbon powder and a fluorinated resin, with a support made of a material such as, for example, carbon paper or woven or non-woven cloth, felt, etc. Metal-based catalyst layers 2_{A} and 2_{C} may, for example, comprise Pt or Ru. MPL 4_{C} may be formed of a composite material comprising an electrically conductive powder such as carbon black and a hydrophobic material such as PTFE.

Completing MEA 9 are respective electrically conductive anode and cathode separators 6_{A} and 6_{C} for mechanically securing the anode 12 and cathode 14 electrodes against PEM 16. As illustrated, each of the anode and cathode separators 6_{A} and 6_{C} includes respective channels 7_{A} and 7_{C} for supplying reactants to the anode and cathode electrodes and for removing excess reactants and liquid and gaseous products formed by the electrochemical reactions. Lastly, MEA 9 is provided with gaskets 5 around the edges of the cathode and anode electrodes for preventing leaking of fuel and oxidant to the exterior of the assembly. Gaskets 5 are typically made of an O-ring, a rubber sheet, or a composite sheet comprised of elastomeric and rigid polymer materials.

As indicated above, a drawback of a conventional DMFC is that the methanol (CH₃OH) fuel partly permeates the PEM 16 of MEA 9 from the anode 12 to the cathode 14, such permeated methanol being termed “crossover methanol”. The crossover methanol reacts with oxygen at the cathode 12, causing a reduction in fuel utilization efficiency and cathode potential, with a corresponding reduction in power generation of the fuel cell.

According to the present disclosure, the previously indicated limitations/drawbacks of hydrocarbon-based PEMs for DOFC/DMFC systems are minimized by modifying the surface of the HC-based PEMs to provide them with desirable surface structures or properties at least similar to those of perfluoropolymers. The resultant surface-treated PEMs advantageously exhibit low methanol crossover with minimal reduction in proton conductivity, thereby facilitating optimal performance operation of DOFC/DMFC systems with very highly concentrated fuel and high power efficiency. In addition, such surface-treated PEMs are more compatible and thus have better interfacial contact with the anode and cathode electrodes of the MEA, and thereby can lead to improved fuel cell performance and long-term stability.

According to the present disclosure, a method is provided for modifying the surface of HC-based PEMs with a solution or dispersion of a perfluoropolymer, such as a perfluorosulfonic acid-tetrafluorethylene copolymer, whereby the surface-treated PEMs incorporate the perfluoropolymer at least on or within the surfaces thereof. In this manner, the PEM can exhibit benefits attributable to the HC-based membrane and the perfluoropolymer. As used herein, the term “hydrocarbon-based membrane” (or “HC-based membrane”) includes a variety of HC-based polymeric materials, including, without limitation, poly-(arylene ether ether ketone) (“PEEK”), sulfonated poly-(arylene ether ether ketone) (“SPEEK”), sulfonated poly-(ether ether ketone ketone) (“SPEEKK”), sulfonated poly-(arylene ether sulfone) (“SPES”), sulfonated poly-(arylene ether benzonitrile), sulfonated polyimides (“SPI”s), sulfonated poly-(styrene), and sulfonated poly-(styrene-b-isobutylene-b-styrene) (“S-SIBS”), and the term “perfluoropolymer” includes, without limitation, perfluorinated sulfonic acids (e.g., Nafion®, Flemion®, Aciplex®), sulfonated tetrafluoroethylene, carboxylic fluoroploymers, and their variations with different equivalent weights (EW), where EW represents the weight of dry polymer per mole of sulfonic acid groups when in the acid form.

By way of illustration, surface treated PEMs according to the present disclosure and suitable for use in DOFC/DMFC systems may be prepared by immersing a hydrocarbon-based membrane in an aqueous solution or dispersion of at least one perfluoropolymer, e.g., an aqueous Nafion® solution or dispersion. In a typical illustrative procedure, a sheet of the HC-based polymer membrane is immersed in an about 1.0 to about 15.0 wt. % Nafion® solution or dispersion, e.g., about 5.0 wt. % at a temperature in the range from about 20 to about 50° C., e.g., about 25° C. for from about 5 to about 60 min., e.g., about 30 min. and then sandwiched between a pair of suitably composed sheets, e.g., polytetrafluoroethylene (Teflon®) sheets and associated metal backing plates, for drying via hot pressing for a predetermined interval from about 1 to about 20 min. at an elevated temperature in the range from about 90 to about 150° C. and high pressure in the range from about 0.01 to about 0.1 tons/cm², e.g., 3 min. at 120° C. and 0.02 tons/cm² (40 lbs./cm²). The surface treated PEMs may then be utilized for forming a MEA.

Surface treated HC-based PEMs prepared according to the various embodiments of the present disclosure or equivalent procedures, whereby at least the surfaces of the HC-based membranes are modified by treatment with the perfluoropolymer, preferably exhibit a number of advantages, including but not limited to:

1. improved bonding between the PEM and the ionomer-containing cathode and anode electrodes, thereby facilitating manufacture of the MEA;

2. reduced MEA ionic resistance;

3. H₂O retention by the HC-based PEM due to the treatment with perfluorosulfonic acid-tetrafluorethylene copolymer for increased proton (H⁺) conductivity; and

4. low MeOH crossover rate characteristic of HC-based membranes.

Advantageously, the combination of enumerated benefits yields MEAs operable in DOFC/DMFC systems at significantly higher power densities, particularly under high MeOH feed concentrations.

As will be demonstrated in the foregoing, the surface-treated HC-based PEMs afforded by the presently disclosed methodology feature a beneficial compromise between proton (H⁺) conductivity and MeOH crossover, thereby leading to DOFC/DMFC systems with improved performance vis-à-vis such systems with conventional polymer electrolytes, especially when operated with high MeOH concentration feedstock, e.g., about 2-4 M or higher MeOH solution.

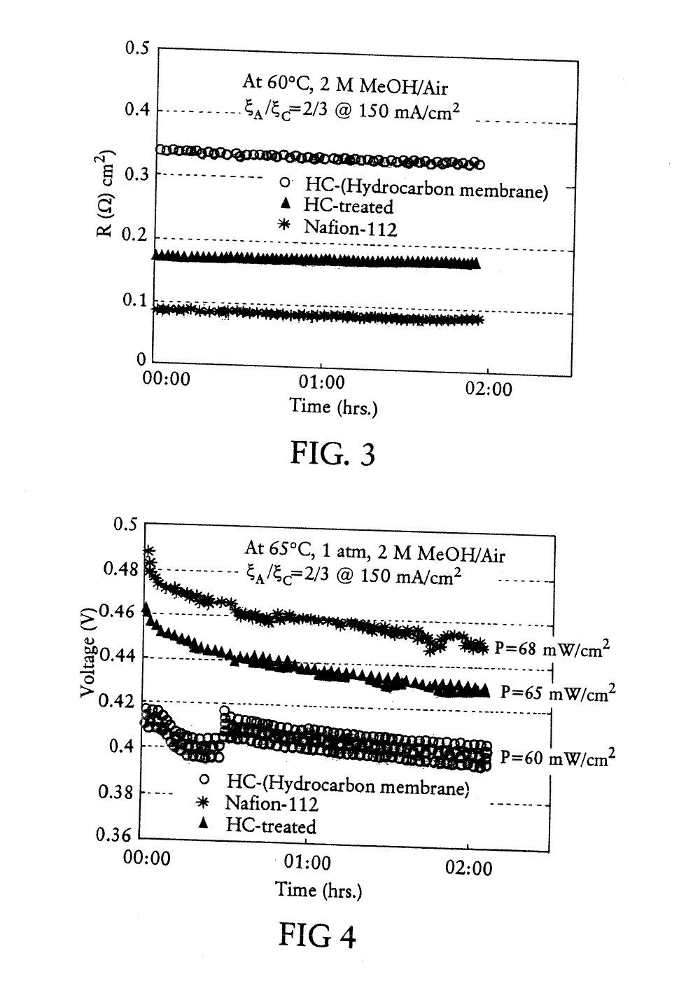

Referring to FIG. 3, shown therein is a graph illustrating the electrical resistance of Nafion®-112 and surface treated and untreated HC-based PEMs, as a function of elapsed time of operation in DMFCs operating with 2M MeOH at 60° C. As is evident from the figure, the internal electrical resistance of the DMFCs with a HC-based PEM was reduced by about 50% by surface treatment with a solution or dispersion of a perfluorosulfonic acid-tetrafluorethylene copolymer (Nafion®-112), i.e., from about 0.33 to about 0.17 Ω/cm². As shown in FIG. 4, which is a graph illustrating the steady-state voltage performance of DMFCs operating with 2M MeOH at 65° C. with Nafion®-112 and surface treated and untreated HC-based PEMs, as a function of elapsed time of operation, a consequence of the reduction in internal resistance of the DMFC with the surface treated HC-based PEM is an increase in power density vis-à-vis the untreated HC-based PEM, i.e., from about 60 to about 65 mW/cm² when operated at 65° C. with a feed of 2M MeOH solution. By way of comparison, the DMFC with the perfluorosulfonic acid-tetrafluorethylene copolymer (Nafion®-112)-based PEM exhibited a power density of about 68 mW/cm² when operated under the same conditions.

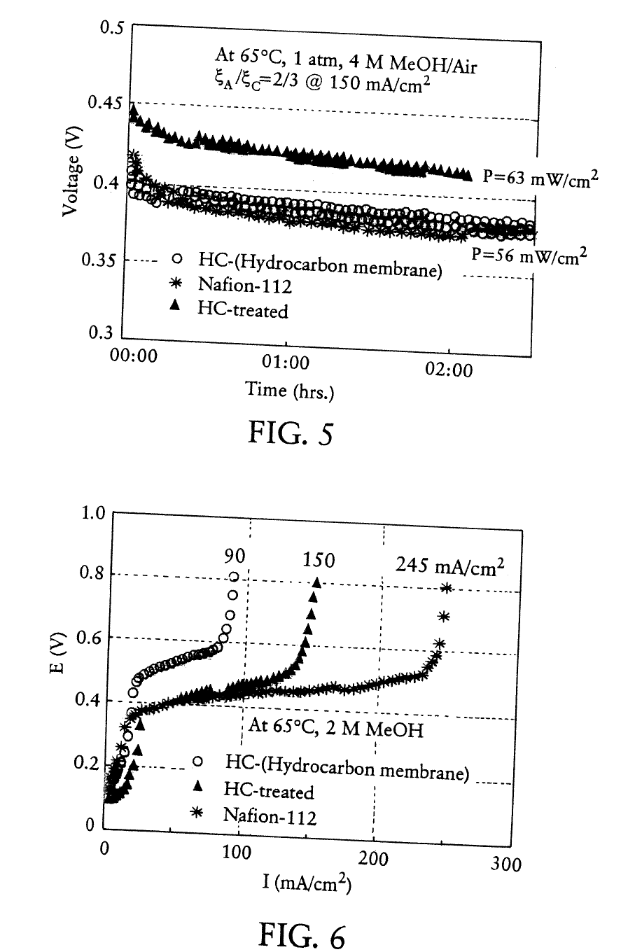

Adverting to FIG. 5, shown therein is a graph illustrating the steady-state voltage performance of DMFCs operating at 1 atm. with 4M MeOH at 65° C. with Nafion®-112 and surface treated and untreated HC-based PEMs, as a function of elapsed time of operation. The advantages afforded when DMFCs with surface-treated HC-based PEMs are operated with 4M MeOH feed are particularly notable. Specifically, DMFCs with untreated HC-based and Nafion®-112 PEMs exhibited power densities of about 56 mW/cm², whereas DMFCs with 62 mm thick surface treated HC-based PEMs exhibited increased power densities of about 63 mW/cm².

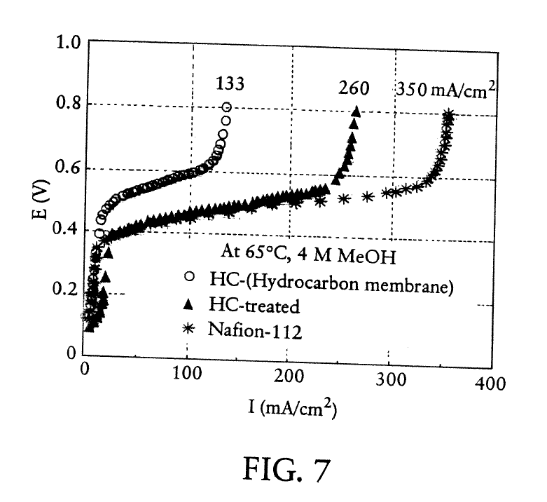

Referring now to FIGS. 6-7, shown therein are graphs respectively illustrating the open circuit MeOH crossover performance of DMFCs operating with 2M and 4M MeOH at 65° C. with Nafion®-112 and surface treated and untreated HC-based PEMs, wherefrom it is observed that the MeOH crossover rates of the surface treated HC-based PEMs fall between those of perfluorosulfonic acid-tetrafluorethylene copolymer (Nafion®-112)-based membranes and untreated HC-based PEMs. The high resistance of the untreated HC-based PEMs (PF-62) prevents attainment of high power densities and the large MeOH crossover rates with the perfluorosulfonic acid-tetrafluorethylene copolymer (Nafion®-112)-based PEMs decreases performance of DMFCs operated with high concentration MeOH feed solutions. By contrast, the surface treated HC-based PEMs fabricated according to the present disclosure exhibit attractive properties of both the hydrocarbon and perfluorosulfonic acid-tetrafluorethylene copolymer.

In summary, therefore, the present disclosure provides ready fabrication of improved PEMs for use in DOFCs such as DMFCs. The modified, i.e., surface treated, PEMs afforded by the instant disclosure advantageously exhibit a beneficial combination of properties, e.g., high proton (H⁺) conductivity and low MeOH crossover, rendering them especially useful in high power density, high energy density DMFC applications. Notable features and advantages of the present disclosure include:

1. the PEM modification is effective in enhancing performance of DOFCs/DMFCs. Specifically, the electrical resistance of the surface treated PEMs is reduced by about 50% relative to untreated HC-based PEMs while MeOH crossover does not significantly increase. The significant decrease in electrical resistance is attributed, at least in part, to substantially improved H₂O retention, while the main hydrocarbon structure maintains the advantage of low MeOH crossover associated with such structures. In addition, interfacial contact between the PEM and the ionomer based layers of the cathode and anode electrodes is improved;

2. the methodology for fabricating the surface treated HC-based PEMs is simple and cost effective in mass production. The properties of the surface treated PEMs fall between the component polymers (i.e., HC and perfluorosulfonic acid-tetrafluorethylene copolymers), analogous to the situation with blended polymer composite materials. While not desirous of being bound by any particular theory or explanation for the observed behavior of the surface treated HC-based PEMs, it is nonetheless believed that the advantageous properties afforded by the present disclosure result from filling of pores of the HC polymer with particles of the perfluorosulfonic acid-tetrafluorethylene copolymer, and the bonding between the different polymers is sufficiently strong due to intermolecular forces, including hydrogen bonding; and

3. the disclosed methodology is useful for modification treatment of all manner and types of HC-based membranes.

In the previous description, numerous specific details are set forth, such as specific materials, structures, reactants, processes, etc., in order to provide a better understanding of the present disclosure. However, the present disclosure can be practiced without resorting to the details specifically set forth. In other instances, well-known processing materials and techniques have not been described in detail in order not to unnecessarily obscure the present disclosure.

Only the preferred embodiments of the present disclosure and but a few examples of its versatility are shown and described in the present disclosure. It is to be understood that the present disclosure is capable of use in various other combinations and environments and is susceptible of changes and/or modifications within the scope of the disclosed concept as expressed herein.

1. A method of fabricating a polymer electrolyte membrane (PEM), comprising steps of:
(a) providing a hydrocarbon (HC)-based polymeric membrane sheet comprising a pair of oppositely facing surfaces; and
(b) treating said pair of surfaces of said membrane with at least one perfluoropolymer to incorporate said polymer on or within at least said pair of surfaces.

2. The method according to claim 1, wherein:
step (a) comprises providing a hydrocarbon-based polymeric membrane sheet comprising a hydrocarbon polymer material selected from the group consisting of: poly-(arylene ether ether ketone) (“PEEK”), sulfonated poly-(arylene ether ether ketone) (“SPEEK”), sulfonated poly-(ether ether ketone ketone) (“SPEEKK”), sulfonated poly-(arylene ether sulfone) (“SPES”), sulfonated poly-(arylene ether benzonitrile), sulfonated polyimides (“SPI”s), sulfonated poly-(styrene), and sulfonated poly-(styrene-b-isobutylene-b-styrene) (“S-SIBS”).

3. The method according to claim 2, wherein:
step (a) comprises providing a hydrocarbon-based polymeric membrane sheet comprising a hydrocarbon polymer material having a thickness from about 15 to about 200 μm.

4. The method according to claim 1, wherein:
step (b) comprises providing at least one perfluoropolymer selected from the group consisting of: perfluorinated sulfonic acids, sulfonated tetrafluoroethylene, carboxylic fluoroploymers, and their variations with different equivalent weights (EW), where EW represents the weight of dry polymer per mole of sulfonic acid groups when in the acid form.

5. The method according to claim 1, wherein:
step (b) comprises treating said pair of surfaces of said membrane with an aqueous solution or dispersion of said at least one perfluoropolymer.

6. The method according to claim 1, wherein:
step (b) comprises surface treating said HC-based polymeric membrane sheet via immersion in an aqueous solution or dispersion of said at least one perfluoropolymer for a predetermined interval at a predetermined temperature, followed by drying of the surface treated polymeric membrane sheet.

7. A surface treated hydrocarbon-based PEM fabricated by the method according to claim 6.

8. A membrane electrode assembly (MEA) comprising anode and cathode electrodes sandwiching a surface treated HC-based PEM fabricated by the method according to claim 6.

9-19. (canceled)
